(19) United States
(12) Patent Application Publication
(10) Pub. No.: US 2025/0045802 A1
(43) Pub. Date: Feb. 6, 2025

(54) AUTOMATED ACTIONABLE INSIGHTS AND CONTENT GENERATION BASED UPON LARGE LANGUAGE MODELS, MULTI-VIEW MACHINE LEARNING, AND GENERATIVE

(71) Applicant: Aleksandr FARSEEV, Singapore (SG)

(72) Inventors: Aleksandr FARSEEV, Singapore (SG); Marlo Antonio Leonardo ONGPIN, Kuala Lumpur (MY); Qi YANG, Datong (CN); Haowen, Alfred, HUANG, Singapore (SG); Sergey NIKOLENKO, St. Petersburg (RU); Kirill LIPIKHIN, Singapore (SG); YU-YI CHU, Singapore (SG)

(21) Appl. No.: 18/766,829

(22) Filed: Jul. 9, 2024

Related U.S. Application Data
(60) Provisional application No. 63/529,814, filed on Jul. 31, 2023.

(51) Int. Cl. G06Q 30/0251; G06Q 30/0241; G06Q 30/0242

(52) U.S. Cl. CPC G06Q 30/0269; G06Q 30/0244; G06Q 30/0251; G06Q 30/0277

(57) ABSTRACT

An apparatus and method are provided, which provide automated analysis and generation of marketing or advertising content, e.g., using large language models (LLMs). The apparatus extracts specific insights from input advertisements, such as needs served, brand personas, products advertised, target audiences, tone, and topical categories. These insights are summarized in the formats commonly used in digital marketing, including brand evaluations, comparative analyses of campaigns, possible future advertising content examples, and examples of user personas together with the imaginary persona stories supporting them. The apparatus may leverage multi-modal prompt engineering to have LLM identify key features of advertisements, generalize analyses, present examples, and generate customer personas, stories, marketing content examples. Sample outputs include brand values and goals identification, persona analysis with examples, campaign differentiators comparison, and Artificial Intelligence (AI)-enhanced customer persona generation. The automation and scalability of such formerly manual marketing tasks provide actionable insights to facilitate rapid and informed decision-making.

### TECHNICAL FIELD OF THE INVENTION

The invention relates to the development and application of advanced technology solutions for automating the analysis, generation, and optimization of marketing and advertising content in digital environments. By leveraging techniques such as machine learning, large language models, and multimodal data processing, this invention is aimed at providing advertisers with actionable insights and recommendations to enhance the effectiveness of their marketing and advertising campaigns in both physical and virtual environments. This invention streamlines a marketing process, enabling advertisers to make informed decisions quickly and efficiently in response to evolving market dynamics and consumer preferences.

### BACKGROUND OF THE INVENTION

The known advertising and content marketing systems rely on proprietary analysis of user data and performance metrics from platforms like Facebook Ads, Google Ads, TikTok Ads, and others. However, marketing and advertising professionals usually do not have the capabilities to process the enormous amount of data and prediction models needed to strategize, create, and optimize their own marketing campaigns.

Platforms may supply various metrics, such as Click-Through-Rate or Engagement Rate for the content that is already used in the advertising campaigns and social media posts, but this provides little actionable guidance for planning and conducting new marketing campaigns, that has not seen the world yet. Therefore, marketers and advertiser need an accessible system that can predict how changes to advertising content will impact performance metrics for new, unseen advertisements and posts. Moreover, they require actionable guidance on the most promising communication scenarios, persona, content when it comes to campaign strategy road mapping and planning. The initial manual analysis of individual marketing content shows promise, but applying such manual techniques to vast volumes of real-world advertising is infeasible given marketers' time constraints and physical restrictions of human-intensive work processes. An evident gap persists between machine learning advances within advertising platforms and advertisers needing practical guidance for improving a campaign impact. What is needed are systems that provide specific, actionable insights directly to marketing and advertising professionals creating and modifying content, crafting communication strategies, analyzing competitor communication traits.

### SUMMARY OF THE INVENTION

This summary is provided to introduce a selection of concepts in a simplified form that are further described below in the detailed description. This summary is not intended to identify key features of the present invention, nor is it intended to be used to limit the scope of the present invention.

It is an objective of the present invention to provide a technical solution that enables automated analysis and generation of marketing or advertising recommendations for subsequent advertising campaigns of a target brand.

The objective above is achieved by the features of the independent claims in the appended claims. Further embodiments and examples are apparent from the dependent claims, the detailed description, and the accompanying drawings.

According to a first aspect, an apparatus for generating an advertising recommendation in an online advertising system is provided. The apparatus comprises at least one processor and a memory storing processor-executable instructions that, when executed by the at least one processor, cause the at least one processor to perform at least as follows. At first, the at least one processor receives a user input comprising a name of a target brand. Then, the at least one processor generates a list of competitors associated with the target brand based on the name of the target brand. Next, the at least one processor uses the name of the target brand and the list of competitors to collect a multimodal dataset from at least one past advertising campaign associated with the target brand and at least one past advertising campaign associated with each competitor of the list of competitors. The multimodal dataset comprises unstructured multimodal features. Further, the at least one processor extracts the multimodal features from the multimodal dataset and structures the extracted multimodal features. After that, the at least one processor generates the advertising recommendation for the target brand by using a Machine-Learning (ML) model. The ML model is configured to receive the structured multimodal features as input data and output the advertising recommendation. The advertising recommendation indicates whether and how to arrange a next advertising campaign for the target brand based on a competitive landscape. If the advertising recommendation indicates that the next advertising campaign is required for the target brand, the advertising recommendation further indicates at least one of: (i) an attention heatmap providing a visual summary of content types for the next advertising campaign; and (ii) one or more keywords for the next advertising campaign.

The apparatus thus configured may provide advertising data analytics and ML-driven prediction: provision of marketing insights based upon audience analysis and advertising content analysis leveraging ML and explainable artificial intelligence (AI), including, but not limited to social media user profiling based on multiple data modalities and social networks, advertising (organic and paid) content clickability prediction, advertising content (organic and paid) clickability prediction visualization, advertising content (organic and paid) engagement rate prediction, advertising content engagement rate prediction (organic and paid) explanatory visualization, advertising content (organic and paid) conversion rate prediction, advertising content (organic and paid) conversion rate prediction explanatory visualization.

Furthermore, the apparatus thus configured may provide:
(1) marketing (or advertising) data summarization where marketing data include but are not limited to multi-view data (images, videos, audio, time-series, textual, etc.), including but not limited to data coming from multiple sources, including but not limited to social networks, search engines, advertising dashboards, websites, public opinion polling databases, stock market information;
(2) quantitative insights (including, but not limited to statistics calculated by mathematical operations by manipulating the data) and ML Inferred insights (predictions, recommendation), and insights inferred by AI models, including, but not limited to, Multi-Source ML and AI and Multi-View ML and AI;
(3) data output in the formats commonly used for audience analysis, including, but not limited to, audience personas, audience sentiment, audience discussed topics, audience discussion trends, audience discussion sentiment traits, audience psychographic profiles, and others. The apparatus enhances traditional audience analysis by generating detailed audience personas and visual representations, offering insights into demographics, interests, preferences, and behavior patterns. Furthermore, it provides sentiment analysis, identifying the emotional tone of audience discussions and highlighting trends and traits in audience sentiment. By leveraging these insights, the apparatus aids advertisers in understanding and engaging with their audience more effectively;
(4) data output in the formats commonly used for advertising campaign performance analysis, including, but not limited to, campaign performance fluctuation analysis, campaign seasonality analysis, campaign audience saturation analysis, campaign auction saturation analysis, campaign ad fatigue, creative change recommendations, campaign setting adjustment recommendations, and others. The apparatus generates actionable recommendations to marketers and advertisers based on the insights derived from data analysis. These recommendations are presented in human-perceivable formats (including, but not limited to, textual, visual, video, sound), accompanied by explanations of the underlying analysis and suggested actions for optimization. By providing clear and actionable guidance, the apparatus empowers advertisers to make informed decisions and improve the effectiveness of their marketing and advertising campaigns.

The apparatus leverages prompts or recommendations, including but not limited to natural language prompt engineering and multi-modal prompt engineering, to have a generative AI model to identify key second-order analytics based upon the supplied aggregated marketing data in the formats explained in the previous paragraphs. Sample outputs demonstrate successful identification of brand values, and goals, detailed persona analysis with examples, comparison of distinguishing factors between campaigns, and full user persona generation supplemented by AI-generated images.

In one exemplary embodiment of the first aspect, the multimodal dataset comprises statistical data, audience data, and content data. The statistical data comprise at least one performance metric for each of the at least one past advertising campaign associated with the target brand and each of the at least one past advertising campaign associated with each competitor of the list of competitors. The audience data comprise at least one type of users which each of the at least one past advertising campaign associated with the target brand and each of the at least one past advertising campaign associated with each competitor of the list of competitors have been intended for. The content data comprise an advertising content used in each of the at least one past advertising campaign associated with the target brand and each of the at least one past advertising campaign associated with each competitor of the list of competitors. By using these data types, the ML model may generate a proper advertising recommendation for the next advertising campaign.

In one exemplary embodiment of the first aspect, the multimodal features comprise tabular data, textual data, visual data, and time-series data. Again, these features may improve the efficiency of predicting the advertising recommendation by the ML model.

In one exemplary embodiment of the first aspect, the at least one processor is further caused, before said generating the advertising recommendation, to fuse the structured multimodal features by one of a data-level fusion technique, a decision-level fusion technique, and a cross-source attention technique. By using these fusion techniques, one may improve the efficiency of the training and inference phases of the ML model.

In one exemplary embodiment of the first aspect, the at least one processor is further caused, before said generating the advertising recommendation, to divide the structured multimodal features into multiple subsets such that each of the multiple subsets corresponds to at least one of a different period, a different advertising location, a different demographic characteristic, and a different creative asset. This division may further improve the efficiency of predicting the advertising recommendation by the ML model.

In one exemplary embodiment of the first aspect, the ML model is further configured to output, for the next advertising campaign, at least one of: a predicted audience profile, a predicted advertising metrics trend, advertising content performance score and metrics, a predicted brand persona, predicted customer needs, predicted customer products, predicted content types, predicted brand communication evidence, predicted brand communication themes, predicted brand discounts, and predicted brand topics. By using these additional data, it is possible to arrange the next advertising campaign more efficiently.

In one exemplary embodiment of the first aspect, the ML model is further configured to output, for the next advertising campaign, at least one of textual and visual information relating to a potential customer of the target brand. By using these additional data, it is possible to arrange the next advertising campaign more efficiently.

In one exemplary embodiment of the first aspect, the visual information comprises a visual representation of the potential customer, and the textual information comprises at least one of: a name of the potential customer, a type of the potential customer, customer demographics associated with the potential customer, feedback to be provided by the potential customer, an interest category of the potential customer, a social angle of the potential customer, an economic aspect of the potential customer, a psychological profile of the potential customer, and examples of online and offline content to be placed by the potential customer. By using these additional data, it is possible to arrange the next advertising campaign more efficiently.

In one exemplary embodiment of the first aspect, the ML model is implemented as a Large Language Model (LLM) (e.g., Multi-Modal LLMs, and their further developments and variants) or a multi-view learning neural network. These types of the ML model may provide the most optimal prediction of the advertising recommendation.

According to a second aspect, a method for generating an advertising recommendation in an online advertising system is provided. The method starts with the step of receiving a user input comprising a name of a target brand. Then, the method proceeds to the step of using the name of the target brand to generate a list of competitors associated with the target brand. Subsequently, the method goes on to the step of using the name of the target brand and the list of competitors to collect a multimodal dataset from at least one past advertising campaign associated with the target brand and at least one past advertising campaign associated with each competitor of the list of competitors. The multimodal dataset comprises unstructured multimodal features. After that, the method proceeds to the steps of extracting the multimodal features from the multimodal dataset and structuring the extracted multimodal features. Further, the method goes on to the step of generating the advertising recommendation for the target brand by using an ML model. The ML model is configured to receive the multimodal features as input data and output the advertising recommendation. The advertising recommendation indicates whether and how to arrange a next advertising campaign for the target brand based on a competitive landscape. If the advertising recommendation indicates that the next advertising campaign is required for the target brand, the advertising recommendation further indicates at least one of: (i) an attention heatmap providing a visual summary of content types for the next advertising campaign; and (ii) one or more keywords for the next advertising campaign.

Exemplary embodiments of the method according to the second aspect and their advantages are similar to those discussed above with respect to the apparatus according to the first aspect.

According to a third aspect, a computer program product is provided. The computer program product comprises a computer-readable storage medium that stores a computer code. Being executed by at least one processor, the computer code causes the at least one processor to perform the method according to the second aspect. By using such a computer program product, it is possible to simplify the implementation of the method according to the second aspect in any computing device, like the apparatus according to the first aspect.

Other features and advantages of the present disclosure will be apparent upon reading the following detailed description and reviewing the accompanying drawings.

### BRIEF DESCRIPTION OF DRAWINGS

To more fully understand the aspects and embodiment of the invention, reference is made to the accompanying drawings. Understanding that these drawings are not to be considered as limitations in the scope of the invention, the presently described aspects and embodiment and the presently understood best embodiment of the invention are described with additional detail through the use of the accompanying drawings, in which like numbers represent the same or similar elements.

FIG. 1 shows a schematic block diagram of an apparatus for generating an advertising recommendation in an online advertising system in accordance with one exemplary embodiment.

FIG. 2 shows a process for collecting advertising data of a target brand and its competitors on digital advertising platforms (or other possible sources of information, explained above), which is performed by a data acquisition module included in the apparatus of FIG. 1, in accordance with one exemplary embodiment.

FIG. 3 shows a process for obtaining content analytics using different techniques, including but not limited to traditional machine learning and deep learning, in accordance with one exemplary embodiment.

FIG. 4 shows a process for extracting multimodal features from digital advertising data, which is performed by a multimodal feature extraction module included in the apparatus of FIG. 1, in accordance with and one exemplary embodiment.

FIG. 5 shows a process for predictive analysis, which is performed by a predictive analytics module included in the apparatus of FIG. 1, in accordance with one exemplary embodiment.

FIG. 6 shows a process for descriptive analysis using a Large Language Model (LLM), which is performed by a descriptive analytics module included in the apparatus of FIG. 1, in accordance with one exemplary embodiment.

FIG. 7 shows examples of extracted semantic features and brand persona analysis examples in accordance with one exemplary embodiment.

FIG. 8 shows a sample visualization of identified keywords and cross-brand comparison in accordance with one exemplary embodiment.

FIG. 9 shows a process for generating customer persona images based on multimodal data from various platforms, which is performed by a content generation module included in the apparatus of FIG. 1, in accordance with one exemplary embodiment.

FIG. 10 shows examples of generated user descriptions and imagined look visualizations of user persona in accordance with one exemplary embodiment.

FIG. 11 shows examples of generated explanations of highlights and content scores based on a visual query of an Artificial Intelligence (AI)-predicted content performance attention heatmap into the LLM.

FIG. 12 shows a process for generating advertising or marketing campaign performance analysis based on multimodal data from various platforms in accordance with one exemplary embodiment.

FIG. 13 shows examples of generated persona story and marketing content descriptions and visualizations in accordance with one exemplary embodiment.

FIG. 14 shows examples of generated marketing campaign performance analysis and recommendation based on multimodal data from various platforms in accordance with one exemplary embodiment.

### DETAILED DESCRIPTION OF THE INVENTION

Various embodiments of the present invention are further described in more detail with reference to the accompanying drawings. However, the present invention can be embodied in many other forms and should not be construed as limited to any certain structure or function discussed in the following description. In contrast, these embodiments are provided to make the description of the present invention detailed and complete.

According to the detailed description, it will be apparent to the ones skilled in the art that the scope of the present invention encompasses any embodiment thereof, which is disclosed herein, irrespective of whether this embodiment is implemented independently or in concert with any other embodiment of the present invention. For example, the apparatus and method disclosed herein can be implemented in practice by using any numbers of the embodiments provided herein. Furthermore, it should be understood that any embodiment of the present invention can be implemented using one or more of the elements presented in the appended claims.

Unless otherwise stated, any embodiment recited herein as “exemplary embodiment” should not be construed as preferable or having an advantage over other embodiments.

To the extent that the terms “including”, “includes”, “having”, “has”, “with”, or variants thereof are used in either the detailed description or the claims, such terms are intended to be inclusive in a similar manner to the term “comprising”.

The ranges of values provided herein do not limit the scope of the present invention. It is understood that each intervening value between the upper and lower limit of that range and any other stated or intervening value in that stated range is encompassed within the scope of the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

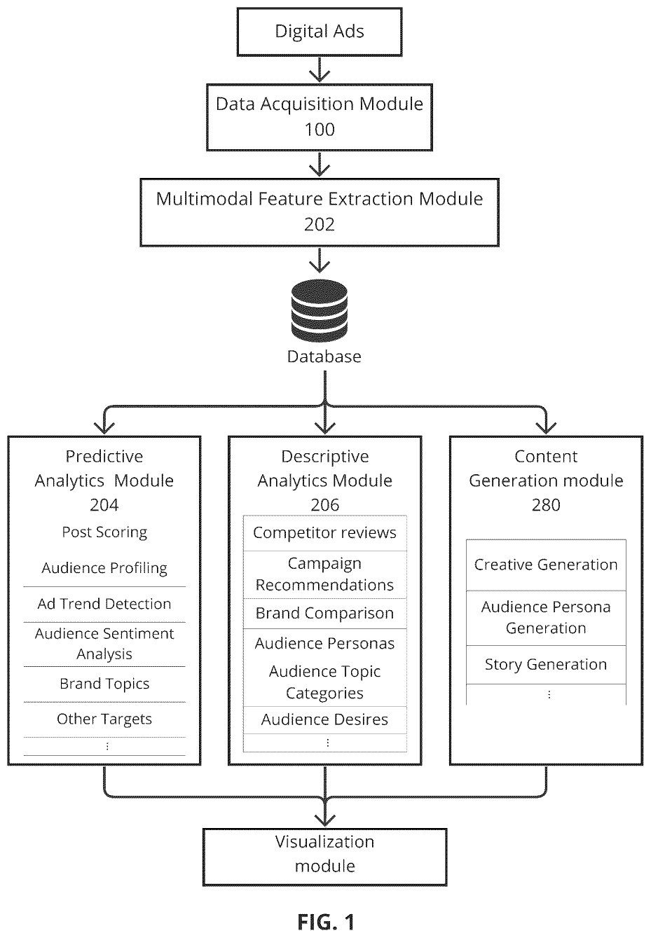

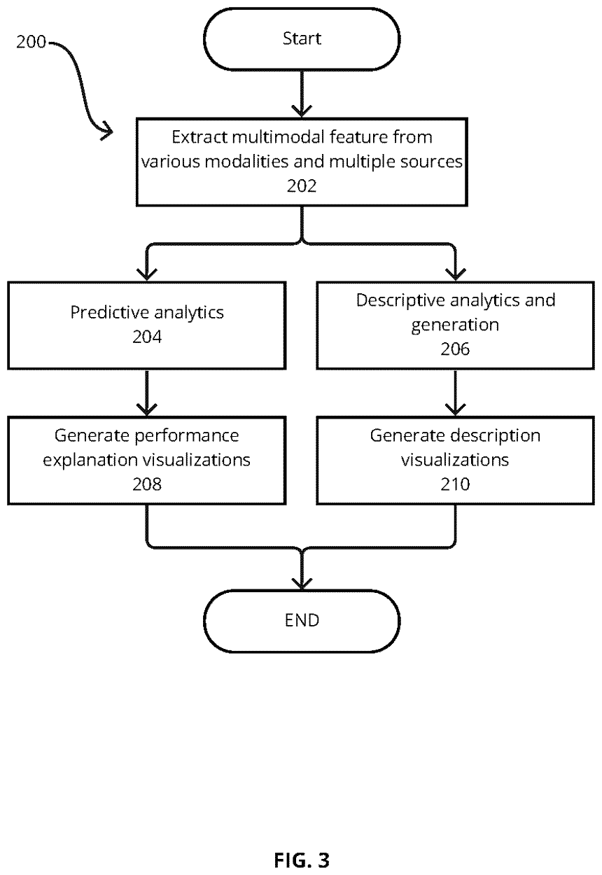

FIG. 1 shows a schematic block diagram of an apparatus for generating an advertising recommendation in an online advertising system in accordance with one exemplary embodiment. The apparatus leverages machine learning and deep learning techniques, such as Large Language Models (LLMs), to automatically analyze online digital ads and generate content. For convenience of illustration, the selected components of the apparatus are described below with respect to FIGS. 3-5 and 7-11.

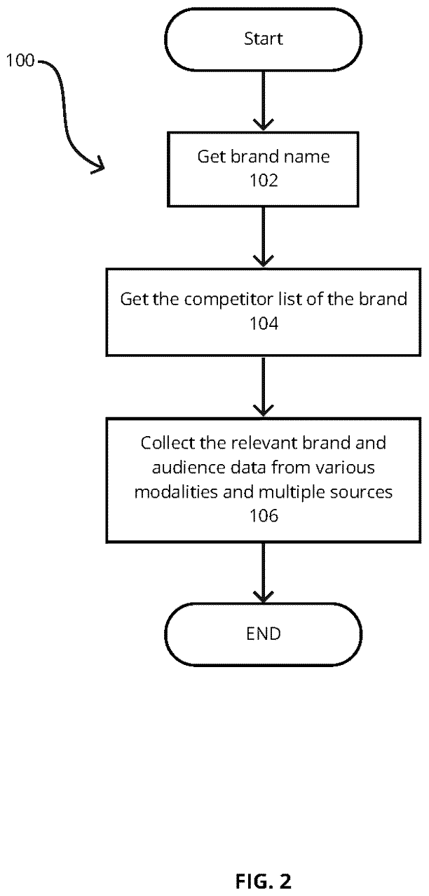

FIG. 2 shows a process collecting advertising data of a target brand and its competitors on digital advertising platforms, which is performed by a data acquisition module 100 of the apparatus of FIG. 1, in accordance with one exemplary embodiment. At step 102, a target brand name is given for collecting the advertising data. Then, at step 104, a list of the brand's competitors is collected. At step 106, historical data from advertising campaigns have been collected based on the collection results at steps 102 and 104. More specifically, in a typical example, the audience data, advertising data, organic content (the information posted on social media without being paid for distribution), ad performance information from an ads manager (metrics, including but not limited to, Click-Through Rate, Conversion Rate, Cost per 1000 Impressions, Cost per 1000 people Reached, Cost per Result, Cost Per Action, Cost per Click, Cost per Engagement, Amount Spent, Cost per Landing Page View), and other potentially related information to the brand may be included and broken down in terms of different measurement units, including but not limited to time, demographics, placement, location, and creative asset.

FIG. 3 shows a process 200 for obtaining content analytics using different techniques, including but not limited to traditional machine learning and deep learning, in accordance with one exemplary embodiment. The process 200 includes multimodal feature extraction from multiple sources at step 202. The multimodal features are extracted based on the dataset prepared at step 106 to allow unstructured, multimodal data to be leveraged by the model at steps 204 and 206. At step 208, the performance explanation in various formats obtained at step 204 is visualized. More specifically, in a typical example, an attention heatmap that highlights the potential area that the audiences may focus on is generated. At step 210, various formats of descriptive analysis results generated at step 206 are visualized. In a general example, the approaches to visualization may include, but are not limited to word clouds for highlighting phrasing preferences, radar maps for highlighting the inferred brand's persona distribution, comparison analytics, AI-generated customer profiling images, and so on.

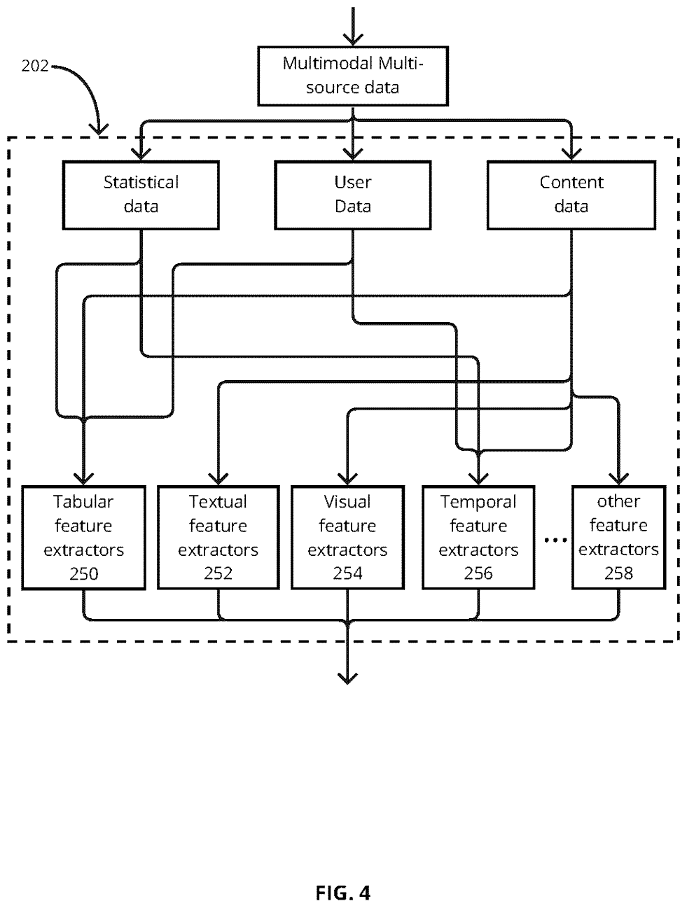

FIG. 4 shows a process for extracting multimodal features from digital advertising data, which is performed by a multimodal feature extraction module 202 included in the apparatus of FIG. 1, in accordance with and one exemplary embodiment. The digital advertising data may include, but are not limited to, the following types of data: statistical data, user data, and content data. In a general example, the input data may be extracted from an advertising campaign, which is provided with one or more ad sets mainly responsible for targeting, i.e., determining which audience is intended to see the ads and on which platforms and positions the ads should be displayed. Each ad set is provided with one or more ads that mainly contain creatives (text, images, video, or other types of content) to be shown to the targeted audiences. Depending on the format, several creatives with different modalities could be provided for each ad (e.g., both images and videos could be provided for use in the “carousel” format).

At steps 250, 252, 254, 256, and 258, various feature extractors included in the multimodal feature extraction module 202 are used to extract features from the multimodal data according to the modality of the content. At step 250, tabular data, including but not limited to continuous data and categorical data, is processed. In a specific practical example, categorical data such as country, advertising objective, advertising platforms, advertising positions, and target audience interests are included and processed with the corresponding feature extractor. At step 252, textual data, including but not limited to text in the creatives, is processed. In a specific practical example, a fine-tuned textual feature extractor is used to extract textual features for each creative. At step 254, visual data, including but not limited to images or videos in the ad data, is processed. In a specific practical example, keyframes are extracted from videos to obtain five images for each creative under each ad. Then, a pretrained visual feature extractor is used to extract visual features, relying on an attention branch network. In addition, textual coverage on the image and entropy values for each of the RGB channels are computed to directly quantify the “messiness” of an image creative since non-organized images are less appealing and, therefore, less likely to garner clicks. At step 256, temporal data, including but not limited to the release time of the ads and the pattern of time for users to interact with ads, is processed. At step 258, other potential content will be processed based on its modality.

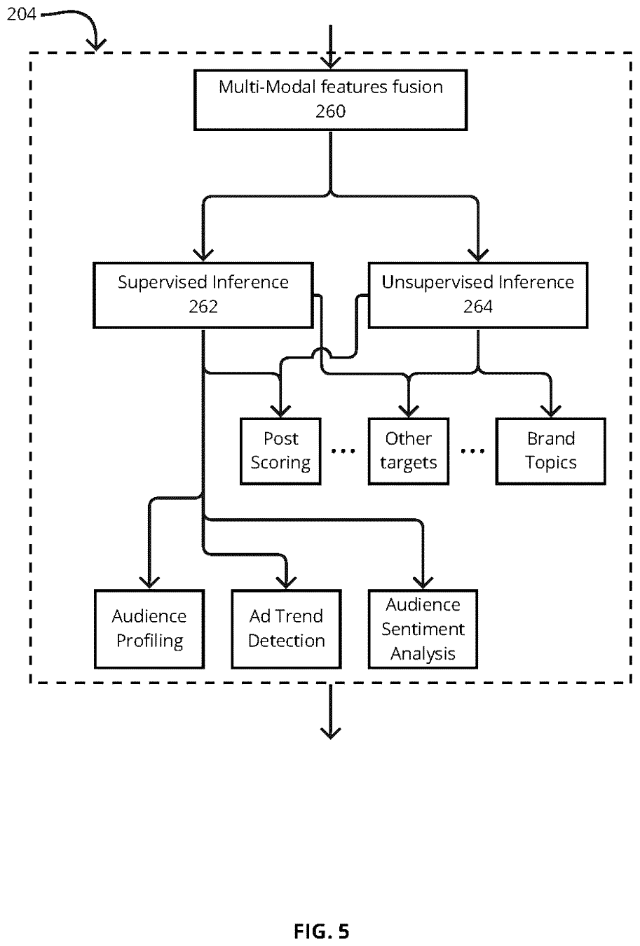

FIG. 5 shows a process for predictive analysis, which is performed by a predictive analytics module 204 included in the apparatus of FIG. 1, in accordance with one exemplary embodiment. At step 260, multimodal features extracted at step 202 are fused for model training and inference. In accordance with the various aspects and embodiments of the invention, various techniques of multimodal data fusion are used. More specifically, in a typical example, data-level fusion, decision-level fusion, cross-source attention, and other potential background data fusion techniques may be included. According to the goals of different content analyses, it can be divided into supervised learning and unsupervised learning. At step 262, supervised model(s) are trained to analyze the content. In a practical example, the goals of analysis may include but are not limited to post scoring, audience profiling, ad trend detection, audience sentiment analysis, and other potential types of analysis. Similarly, at step 264, unsupervised model(s) are trained to analyze the content. In a practical example, the goals of analysis may include but are not limited to post scoring, brand topic clustering, and other potential types of analysis.

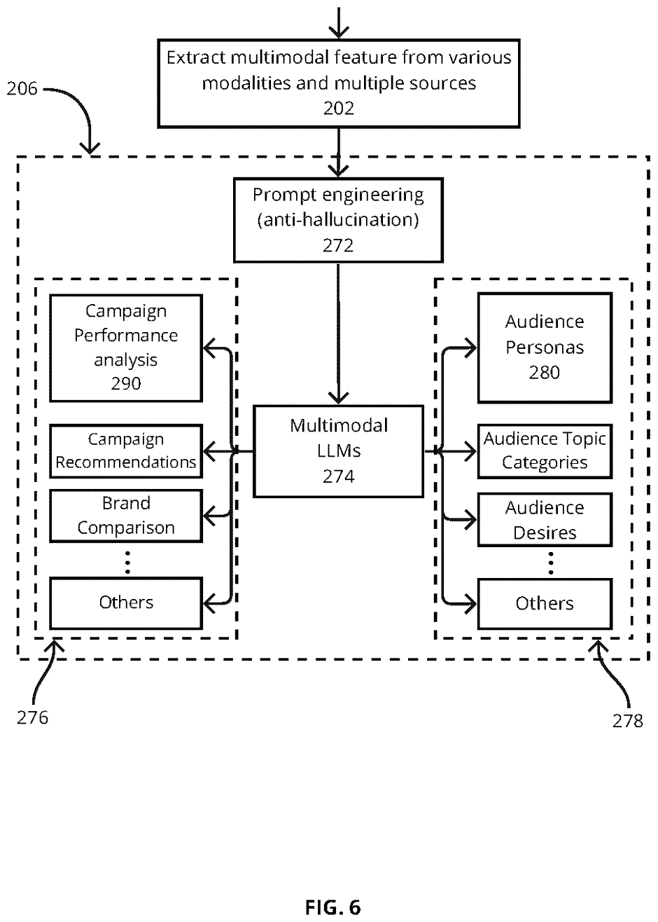

FIG. 6 shows a process for descriptive analysis using a Large Language Model (LLM), which is performed by a descriptive analytics module 206 included in the apparatus of FIG. 1, in accordance with one exemplary embodiment. At step 272, the semantic features extracted by the multimodal feature extraction module 202 are retrieved from the database based on a specific query, and proper prompts for analyzing the retrieved features based on the conditions are designed to eliminate LLM hallucination, which is the models property of generating outputs with conclusions that are unrelated to the context of the data fed into the model as input. In accordance with the various aspects and embodiments of the invention, the query can differ to fit various analysis conditions. For example, the features can be retrieved based on the brand name, the date range of the ads, the category of the ads, the analysis category, the analysis type, and keywords. In accordance with the various aspects and embodiments of the invention, the analysis category can include the single brand with a single date range, a single brand with multiple date ranges, multiple brands with a single date range, and multiple brands with multiple date ranges. Similarly, in this invention, analysis types can include but are not limited to one or multiple aspects as demonstrated in step 276 and step 278: competitor reviews, campaign recommendations, brand comparison, audience personas, audience topic categories, audience desires, and so on. At step 274, the properly engineered prompt is fed into the multimodal large language model to generate analysis and corresponding recommendations.

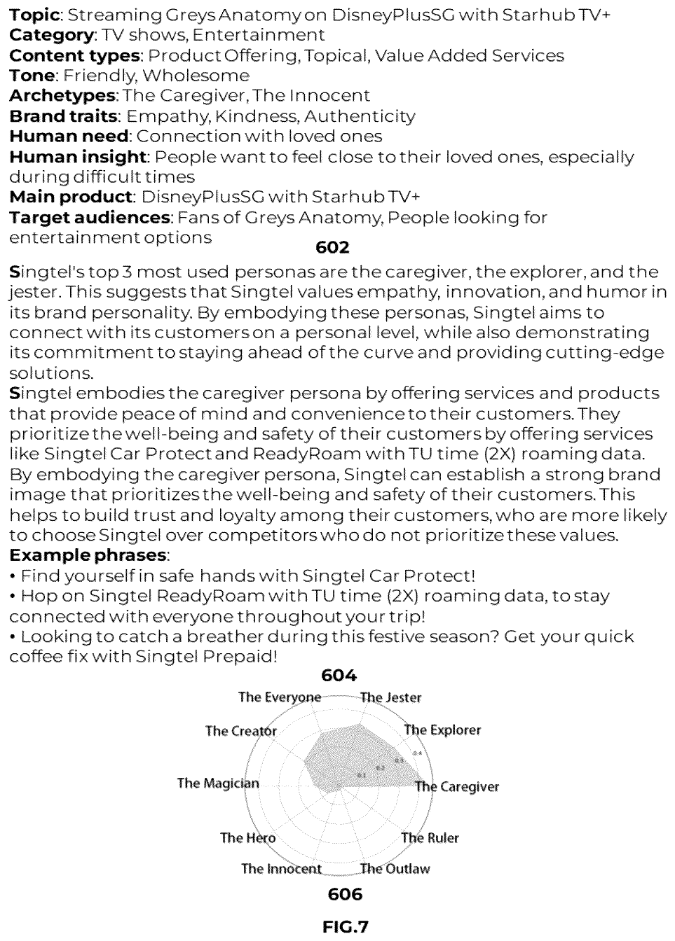

FIG. 7 shows various examples inferred from the LLM, such as extracted semantic features 602 and brand persona analysis examples 604. As follows from the features 602, the LLM has been able to successfully identify key features of each advertisement, including excellent responses to seemingly “human” questions such as identifying human needs, human insights, and the brand archetypes brand exhibited in a marketing content piece. Furthermore, other important marketing parameters could be identified, including but not limited to audience profile, advertising metrics trend, advertising content performance score and performance metrics, brand persona, brand topics, customer needs, customer products, brand communication theme, content types, brand communication evidence, brand discounts, brand topics. Moreover, answers to most questions are standardized (as the LLM has been instructed) and can be subject to automated processing.

In the examples 604, a sample outcome of the brand persona analysis is demonstrated, encompassing the main brand values utilized in the advertising campaigns, the objectives behind their utilization, and a comprehensive analysis of the primary “caregiver” persona, inclusive of supporting examples from the data. The ads and extracted features are used as inputs for a range of prompts that are employed to summarize information in various formats frequently utilized in digital marketing. Successful summarization has been observed universally, with significant insights being provided by the LLM and showcased in a format that is accessible and can be acted upon. The associated persona analysis radar chart is displayed in example 606.

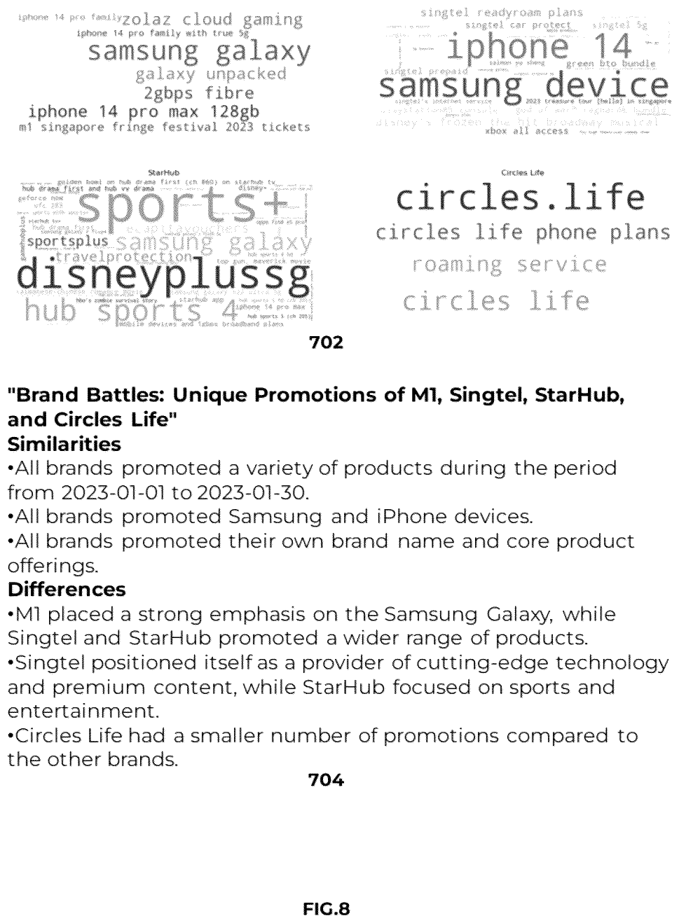

FIG. 8 shows various examples of cross-brand comparison inferred from the LLM, such as the visualization of identified products 702 and cross-brand comparison 704. The cross-band comparison 704 shows the results of key distinguishing factors comparative analysis of four advertising campaigns run over the same time period by different brands. The products 702 show the brands' products identified in the ads.

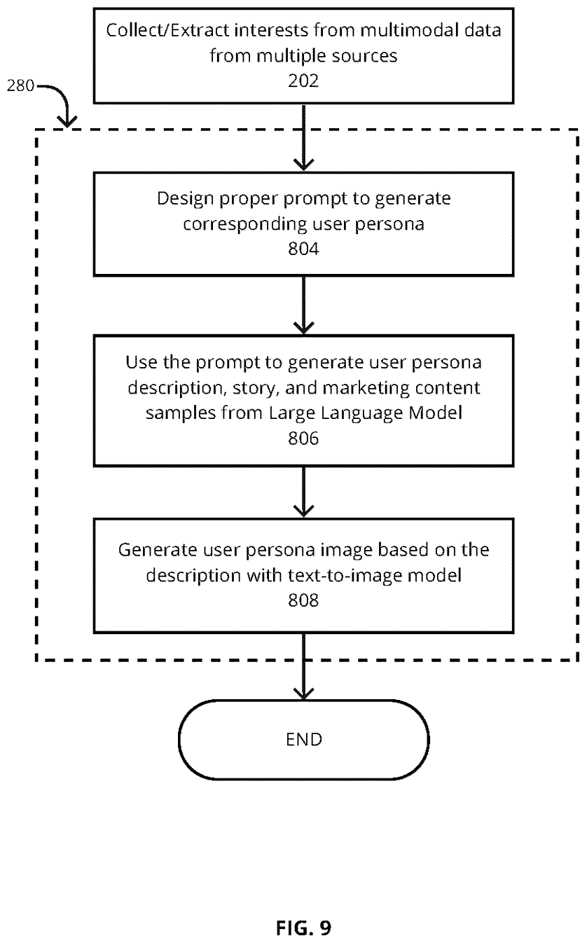

FIG. 9 shows a process for generating customer persona images based on multimodal data from various platforms, which is performed by a content generation module 280 included in the apparatus of FIG. 1, in accordance with one exemplary embodiment. More specifically, the process of FIG. 9 is aimed at generating the brand customer's sample (imagined) persona image based on the description generated from the multi-source multimodal data. At step 804, a prompt is designed to be fed into the LLM to provide examples of customer descriptions that could align with the interests collected at step 202 and brand communication style reflected from the existing marketing campaigns executed by the brand and competitors. At step 806, the interests and the designed prompt are combined and fed into the LLM to generate examples of customer descriptions. At step 808, user persona or profiling images are generated based on these examples of user descriptions by a state-of-the-art multi-modal image generation model.

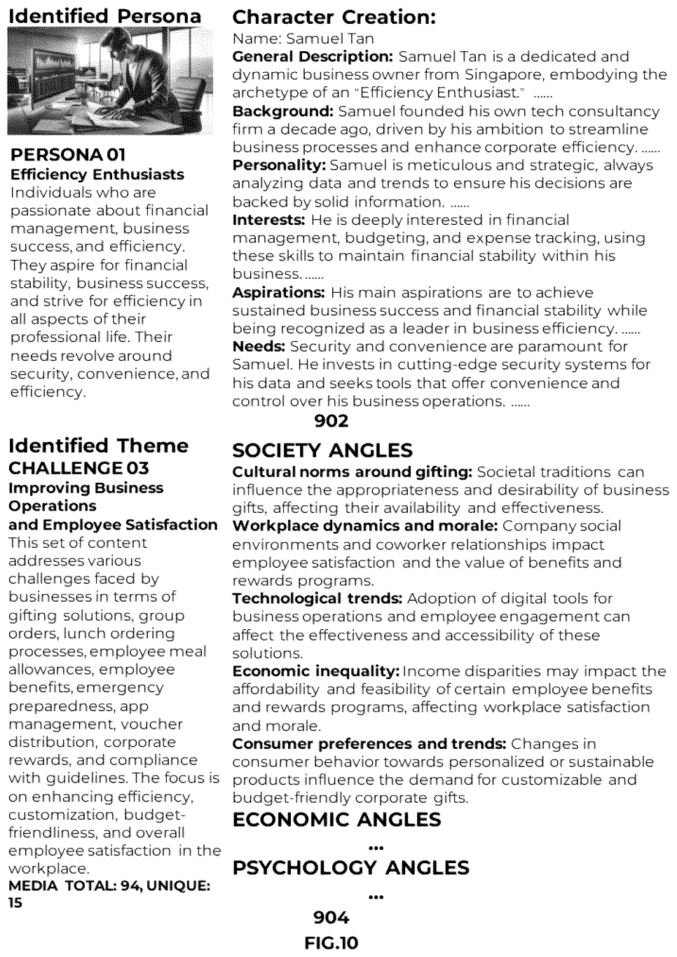

FIG. 10 shows various examples inferred from the LLM, such as customer persona description, visualization, and persona character description 902 and various communication angles describing the persona identified from the competitor content communication in their content 904. The description 902 shows the identified from the brand communication data and generated customer persona snapshot and character description in terms of general character traits, which includes person character aspects, such as persona imaginary name, background, personality, interests, aspirations, and needs. The content 904 shows the sample customer persons communication theme generated with respect to the sample challenge identified from the data, which includes challenge description, social angles, economic aspects, and psychological profiles, which are all identified from the data by the LLM.

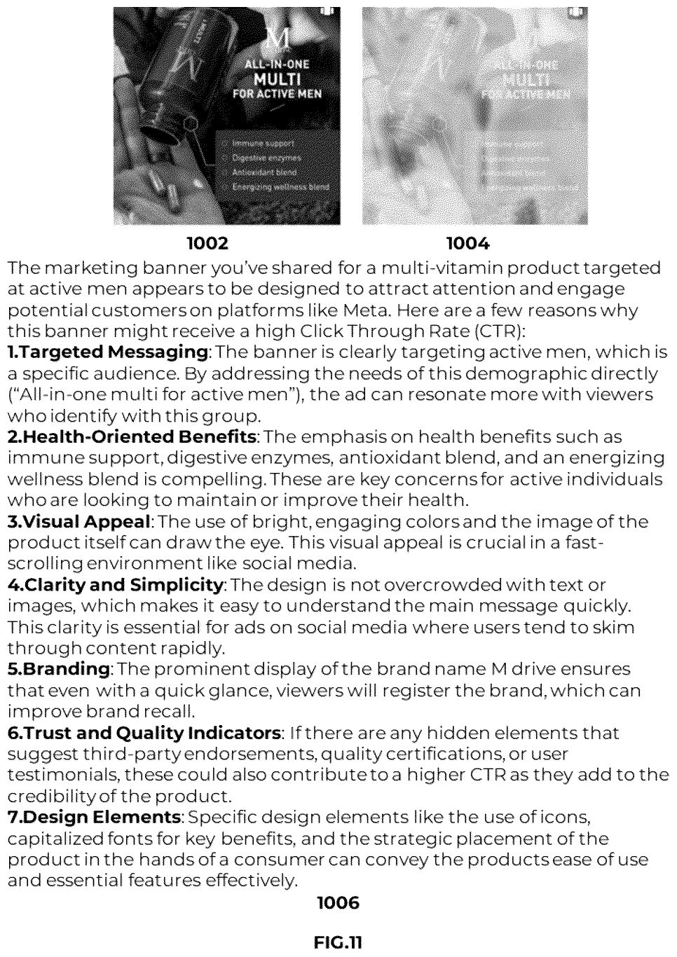

FIG. 11 shows the original advertising content, the generated attention heatmap, and the LLM-based content description. The LLM-generated explanation of the original advertising content and the heatmap is described on 1006, a sample advertising content is shown on 1002, and an AI-generated attention heatmap pointing to the most important areas of the image that are in charge of the predicted content performance score is shown on 1004.

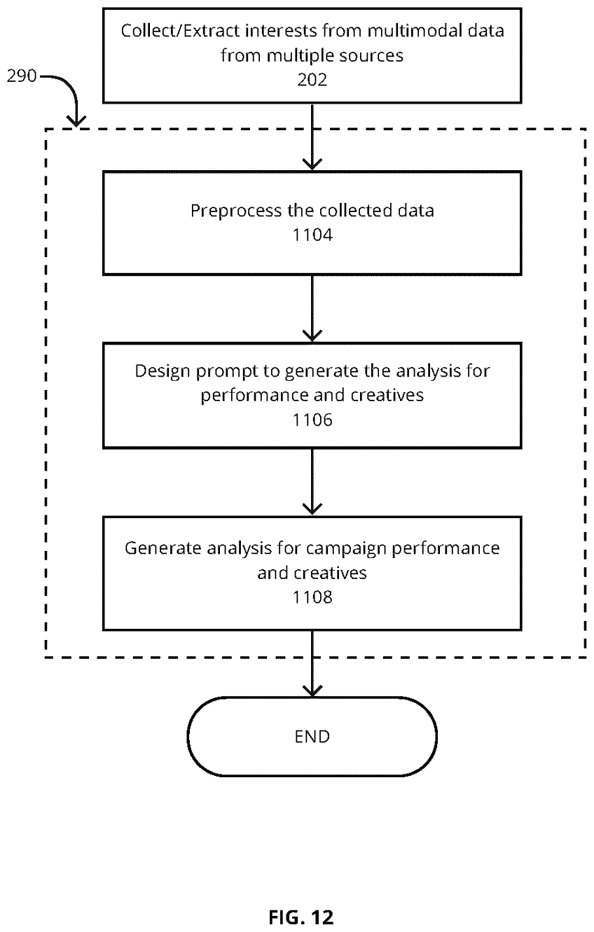

FIG. 12 shows a process 290 for generating performance analysis based on the campaign performance and creative data. At step 1102, a processor is designed to process the campaign performance feature and creative feature extracted at step 202. The extracted feature is combined with the pre-designed prompt at step 1104. At step 1106, the prompt is fed to the multi-modal LLM to generate the analysis of the content performance in a human-readable form explaining the heatmap and specific properties of the content affecting its performance if being used in an advertising or marketing campaign.

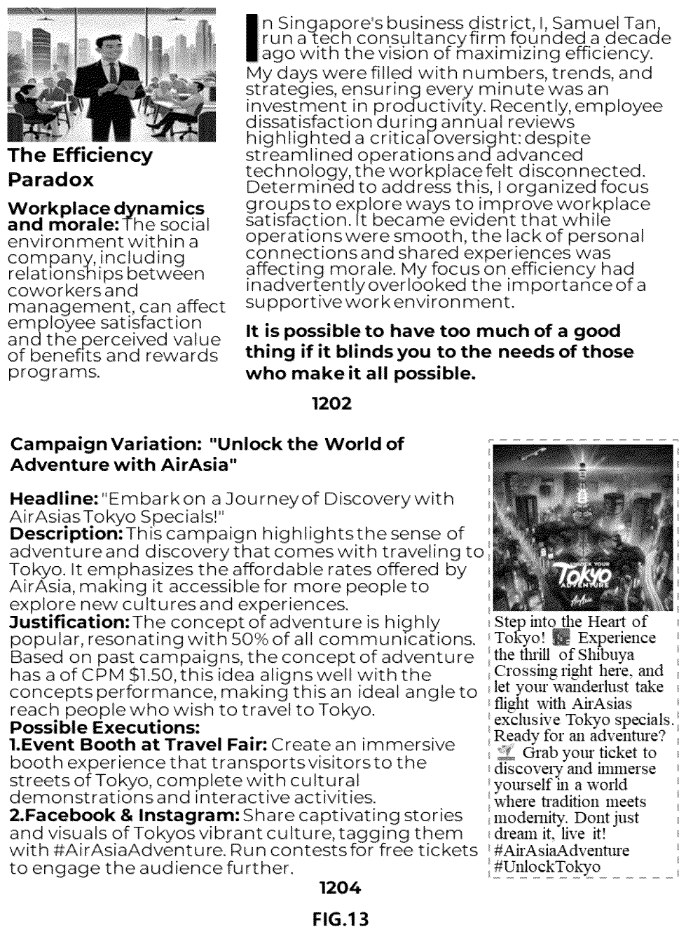

FIG. 13 shows an example of a customer persona story 1202 and a marketing content idea 1204. The story 1202 is a story and the story summary line generated based on customer persona, which, in turn, is generated according to the output of the step 808. The idea 1204 shows a marketing and advertising content description and visual examples as well as content placement (channel, including but not limited to, Meta Platform, Instagram Platform, Google Display Network, Trade Shows, etc.) recommendation generated based on the customer persona story from the story 1202 and the customer persona generated from the process finalized at step 808.

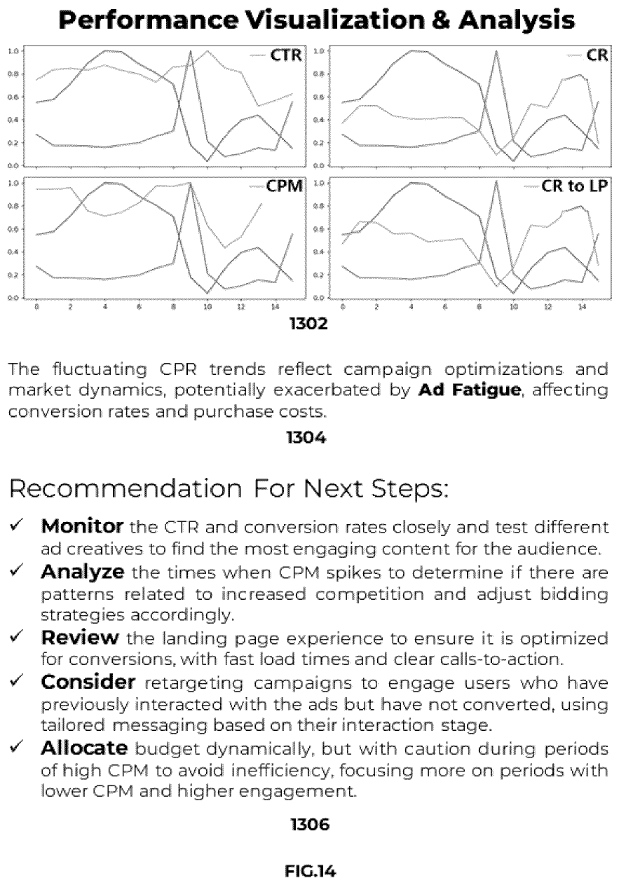

FIG. 14 shows an example of advertising campaign analysis and recommendation based on campaign statistics. The example shows the campaign statistics revealing trends of various performance advertising metrics, such as Spend, Cost Per Result, Click-Through Rate 1302, possible reason of advertising campaigns performance fluctuation, particularly “Ad Fatigue” in a displayed example 1304, drawn from a set of multi-modal advertising campaign statistics, and provides a set of actionable recommendations 1306, including but not limited to landing page reviews, campaign objective changes, campaign metric monitoring, campaign metric analysis, and budget allocation, and according to the process described in steps 1104, 1106, and 1108.

1. An apparatus for generating an advertising recommendation in an online advertising system, comprising:
at least one processor; and
a memory coupled to the at least one processor and storing processor-executable instructions which, when executed by the at least one processor, cause the at least one processor to:
receive a user input comprising a name of a target brand;
based on the name of the target brand, generate a list of competitors associated with the target brand;
based on the name of the target brand and the list of competitors, collect a multimodal dataset from at least one past advertising campaign associated with the target brand and at least one past advertising campaign associated with each competitor of the list of competitors, the multimodal dataset comprising unstructured multimodal features;
extract the multimodal features from the multimodal dataset;
structure the extracted multimodal features; and
generate the advertising recommendation for the target brand by using a Machine-Learning (ML) model, the ML model being configured to receive the structured multimodal features as input data and output the advertising recommendation, the advertising recommendation indicating whether and how to arrange a next advertising campaign for the target brand based on a competitive landscape;
wherein, if the advertising recommendation indicates that the next advertising campaign is required for the target brand, the advertising recommendation further indicates at least one of: (i) an attention heatmap providing a visual summary of content types for the next advertising campaign; and (ii) one or more keywords for the next advertising campaign.

2. The apparatus of claim 1, wherein the multimodal dataset comprises statistical data, audience data, and content data, and wherein the statistical data comprise at least one performance metric for each of the at least one past advertising campaign associated with the target brand and each of the at least one past advertising campaign associated with each competitor of the list of competitors, the audience data comprise at least one type of users which each of the at least one past advertising campaign associated with the target brand and each of the at least one past advertising campaign associated with each competitor of the list of competitors have been intended for, and the content data comprise an advertising content used in each of the at least one past advertising campaign associated with the target brand and each of the at least one past advertising campaign associated with each competitor of the list of competitors.

3. The apparatus of claim 1, wherein the multimodal features comprise tabular data, textual data, visual data, and time-series data.

4. The apparatus of claim 1, wherein the at least one processor is further caused, before said generating the advertising recommendation, to fuse the structured multimodal features by one of a data-level fusion technique, a decision-level fusion technique, and a cross-source attention technique.

5. The apparatus of claim 1, wherein the at least one processor is further caused, before said generating the advertising recommendation, to divide the structured multimodal features into multiple subsets such that each of the multiple subsets corresponds to at least one of a different period, a different advertising location, a different demographic characteristic, and a different creative asset.

6. The apparatus of claim 1, wherein the ML model is further configured to output, for the next advertising campaign, at least one of:
a predicted audience profile,
a predicted advertising metrics trend,
advertising content performance score and metrics,
a predicted brand persona,
predicted customer needs,
predicted customer products,
predicted content types,
predicted brand communication evidence,
predicted brand communication themes,
predicted brand discounts, and
predicted brand topics.

7. The apparatus of claim 1, wherein the ML model is further configured to output, for the next advertising campaign, at least one of textual and visual information relating to a potential customer of the target brand.

8. The apparatus of claim 7, wherein the visual information comprises a visual representation of the potential customer, and wherein the textual information comprises at least one of:
a name of the potential customer,
a type of the potential customer,
customer demographics associated with the potential customer,
feedback to be provided by the potential customer,
an interest category of the potential customer,
a social angle of the potential customer,
an economic aspect of the potential customer,
a psychological profile of the potential customer, and
examples of online and offline content to be placed by the potential customer.

9. The apparatus of claim 1, wherein the ML model is implemented as a Large Language Model (LLM) or a multi-view learning neural network.

10. A method for generating an advertising recommendation in an online advertising system, comprising:
receiving a user input comprising a name of a target brand;
based on the name of the target brand, generating a list of competitors associated with the target brand;
based on the name of the target brand and the list of competitors, collecting a multimodal dataset from at least one past advertising campaign associated with the target brand and at least one past advertising campaign associated with each competitor of the list of competitors, the multimodal dataset comprising unstructured multimodal features;
extracting the multimodal features from the multimodal dataset;
structuring the extracted multimodal features; and
generating the advertising recommendation for the target brand by using a Machine-Learning (ML) model, the ML model being configured to receive the structured multimodal features as input data and output the advertising recommendation, the advertising recommendation indicating whether and how to arrange a next advertising campaign for the target brand based on a competitive landscape;
wherein, if the advertising recommendation indicates that the next advertising campaign is required for the target brand, the advertising recommendation further indicates at least one of: (i) an attention heatmap providing a visual summary of content types for the next advertising campaign; and (ii) one or more keywords for the next advertising campaign.

11. The method of claim 10, wherein the multimodal dataset comprises statistical data, audience data, and content data, and wherein the statistical data comprise at least one performance metric for each of the at least one past advertising campaign associated with the target brand and each of the at least one past advertising campaign associated with each competitor of the list of competitors, the audience data comprise at least one type of users which each of the at least one past advertising campaign associated with the target brand and each of the at least one past advertising campaign associated with each competitor of the list of competitors have been intended for, and the content data comprise an advertising content used in each of the at least one past advertising campaign associated with the target brand and each of the at least one past advertising campaign associated with each competitor of the list of competitors.

12. The method of claim 10, wherein the multimodal features comprise tabular data, textual data, visual data, and time-series data.

13. The method of claim 10, further comprising, before said generating the advertising recommendation, fusing the structured multimodal features by one of a data-level fusion technique, a decision-level fusion technique, and a cross-source attention technique.

14. The method of claim 10, further comprising, before said generating the advertising recommendation, dividing the structured multimodal features into multiple subsets such that each of the multiple subsets corresponds to at least one of a different period, a different advertising location, a different demographic characteristic, and a different creative asset.

15. The method of claim 10, wherein the ML model is further configured to output, for the next advertising campaign, at least one of:
a predicted audience profile,
a predicted advertising metrics trend,
advertising content performance score and metrics,
a predicted brand persona,
predicted customer needs,
predicted customer products,
predicted content types,
predicted brand communication evidence,
predicted brand communication themes,
predicted brand discounts, and
predicted brand topics.

16. The method of claim 10, wherein the ML model is further configured to output, for the next advertising campaign, at least one of textual and visual information relating to a potential customer of the target brand.

17. The method of claim 16, wherein the visual information comprises a visual representation of the potential customer, and wherein the textual information comprises at least one of:
a name of the potential customer,
a type of the potential customer,
customer demographics associated with the potential customer,
feedback to be provided by the potential customer,
an interest category of the potential customer,
a social angle of the potential customer,
an economic aspect of the potential customer,
a psychological profile of the potential customer, and
examples of online and offline content to be placed by the potential customer.

18. The method of claim 10, wherein the ML model is implemented as a Large Language Model (LLM) or a multi-view learning neural network.

19. A computer program product comprising a computer-readable storage medium, wherein the computer-readable storage medium stores a computer code which, when executed by at least one processor, causes at least one processor to perform the method according to claim 10.
